(19) United States
(12) Patent Application Publication
(10) Pub. No.: US 2002/0010640 A1
(43) Pub. Date: Jan. 24, 2002

(54) Technique for securely conducting online transactions

(76) Inventors: Rana Dutta, Shelton, CT (US); Richard H. Rosen, Trumbull, CT (US); George M. Brookner, Norwalk, CT (US); Debra N. Disbrow, Seymour, CT (US)

Correspondence Address: PERMAN & GREEN, 425 POST ROAD, FAIRFIELD, CT, 06430, US

(21) Appl. No.: 09/833,993

(22) Filed: Apr. 12, 2001

Related U.S. Application Data
(60) Provisional application No. 60/196,873, filed on Apr. 12, 2000.

(51) Int. Cl. G06F 17/60

(52) U.S. Cl. 705/26

(57) ABSTRACT

In e-commerce, customers conduct transactions with merchant servers on the Internet, which are associated with different merchants. A financial data center is established to handle the finance attendant to the online transactions, in accordance with an inventive financial service. Each merchant participating in the inventive financial service maintains a merchant account in the financial data center. Similarly, each customer subscribing to the inventive financial service maintains a user account in the financial data center. In conducting an online transaction, after a customer makes a purchase from a merchant server, the merchant server communicates purchase information to the financial data center. In response, the financial data center identifies the corresponding user and merchant accounts. Upon receiving an affirmation of the purchase from the customer, the financial data center transfers the purchase amount from the user account to the merchant account to complete the online transaction.

### TECHNICAL FIELD

The invention relates to a technique for conducting transactions over a communications network, e.g., the Internet.

### BACKGROUND OF THE INVENTION

In e-commerce, a customer typically establishes an Internet connection to access a merchant website to purchase a product or service. At the merchant website, the customer selects the product or service he/she desires to purchase. To consummate the online transaction, the user is typically required to provide personal financial information, e.g., a credit card number, through the established Internet connection. With the received credit card number, the merchant can then charge an amount for the selected product or service to the user credit card account. The product or service, as purchased, is then delivered by the merchant to the customer.

As is well known, the Internet is a packet switched network comprising a large number of nodes. As the personal financial information traverses the network and is routed from node to node, the information is obtainable at the intervening nodes which are controlled by neither the merchant nor the customer. Thus, there is a prevailing perception that information traversing the Internet is exposed to third parties and susceptible to theft. A significant number of would-be customers having such a perception refrain from conducting online transactions for fear that a third party may obtain their personal financial information to commit fraud.

In prior art, methodologies have been developed to help reduce such a fear; one such methodology involves a one-time customer registration at a merchant website before conducting any transaction. During the registration, which is typically online, the customer is required to provide personal financial data, e.g., a credit card number, and is afforded selection of a user identification (ID) and password for conducting subsequent transactions. Thus, when the customer conducts a subsequent transaction at the website, the customer is required to enter his/her user ID and password instead of the credit card number. Based on the user ID and password entry, the user credit card number provided earlier can be retrieved to charge for the transaction. Thus, this methodology obviates use of actual credit card numbers to conduct online transactions. However, it proves to be inconvenient to a customer who transacts with multiple merchant websites at a time as he/she needs to repeatedly enter the user ID and password at each website. It even proves to be burdensome when such a customer uses different sets of user IDs and passwords for the websites. This is because to transact with each website, he/she also needs to correctly recall the corresponding set of user ID and password.

To remedy the shortcomings of the abovedescribed methodology, a service has been developed where the merchant websites participating in the service afford a uniform checkout process to consummate transactions. A customer subscribing to the service is automatically identified during the uniform checkout process at a participating merchant website. The service then transmits the personal financial information of the identified customer through a secure link to the merchant website to complete the transaction.

### SUMMARY OF THE INVENTION

We have recognized that the prior art techniques described above for conducting online transactions invariably require or cause the merchant websites to keep records of customers' personal financial information therein. Depending on the security of the individual merchant websites, which may vary drastically from one to another, the personal financial information stored in any unsecure websites is subject to theft by computer hackers breaking thereinto.

However, in accordance with an inventive financial service, no customers' personal financial information is kept at merchant websites. Rather, it is stored in a financial server which handles the finance attendant to the online transactions between customers and the merchant websites. Thus, by using the inventive service, only the financial server is required to be equipped with stringent, normally costly, security measures against any hackers stealing the sensitive personal financial information stored therein, as opposed to requiring each merchant website to be equipped with the costly security measures as would be in the prior art case. Advantageously, the inventive financial service enables each merchant participating in the service to save costs on the website security. At the same time, appreciating the stringent security of the financial server, the customers are confident in conducting online transactions with the participating merchant websites, thereby increasing their sales.

In accordance with the inventive financial service, a customer account is established for each customer subscribing to the service. Similarly, a merchant account is established for each merchant website participating in the service. The account balance of the customer account and that of the merchant account are stored within the financial server, along with the sensitive financial information required for funding the respective accounts. After a customer makes a purchase from a merchant website using the inventive financial service, the merchant website provides to the financial server information concerning the purchase via a first communication connection. This information includes, among others, a purchase amount, a first identification for identifying the customer account and a second identification for identifying the merchant account. To complete the purchase, the customer provides to the financial server an affirmation of the purchase via a second communication connection. In response to such an affirmation, the financial server causes a transfer of a value between the customer account and the merchant account, where the value is a function of the purchase amount.

### BRIEF DESCRIPTION OF THE DRAWINGS

Further objects, features and advantages of the invention will become apparent from the following detailed description taken in conjunction with the accompanying drawing, in which:

FIG. 1 illustrates an arrangement for conducting online transactions in accordance with the invention;

FIG. 2 illustrates a first web page provided by a merchant server system in the arrangement of FIG. 1;

FIG. 3 illustrates a second web page provided by the merchant server system;

FIG. 4 illustrates a third web page provided by the merchant server system;

FIG. 5 illustrates a fourth web page provided by the merchant server system;

FIG. 6 is a block diagram of a financial data center for handling the finance attendant to the online transactions in accordance with the invention;

FIG. 7 illustrates the format of a user record stored in the financial data center;

FIG. 8 illustrates the format of a merchant record stored in the financial data center;

FIG. 9 illustrates a routine for processing information from the server system concerning an online transaction;

FIGS. 10A and 10B jointly illustrate a routine for processing information concerning an online transaction from a client terminal in the arrangement of FIG. 1;

FIG. 11 illustrates a display on the client terminal concerning the online transaction; and

FIG. 12 illustrates a generic arrangement for conducting online transactions in accordance with the invention.

### DETAILED DESCRIPTION

FIG. 1 illustrates a communications arrangement embodying the principles of the invention for conducting online transactions. In this illustrative arrangement, server system 100 is administered and maintained by a merchant, referred to as to allow users to purchase products or services therefrom via a communication network. By way of example, server system 100 in this instance allows users to purchase tickets therefrom via World Wide Web (WWW) 140, which is a graphical subnetwork of the Internet. System 100 works compatibly with conventional web browsers such as the NETSCAPE NAVIGATOR and INTERNET EXPLORER browsers, the standard hypertext markup language (HTML), and hypertext transfer protocol (HTTP), which may be the secure hypertext transfer protocol (HTTPS) using a secure socket layer (SSL) to transfer information. In any event, the HTTP and HTTPS hereinafter are generically referred to as the HTTP.

In this instance, a user, referred to as “XYZ,” utilizes a client terminal 130 to access the website served by system 100 through WWW 140 at a predetermined uniform resource locator (URL). Client terminal 130 may be a personal computer (PC) running conventional web browser 145 thereon. In accessing system 100, browser 145 establishes a communication connection to HTTP processor 109 having a common gateway interface (not shown), which includes programs defining certain functions of processor 109 described below. In accordance with the invention, financial data center 150, also described below, is connected to WWW 140 to handle the finance attendant to online transactions.

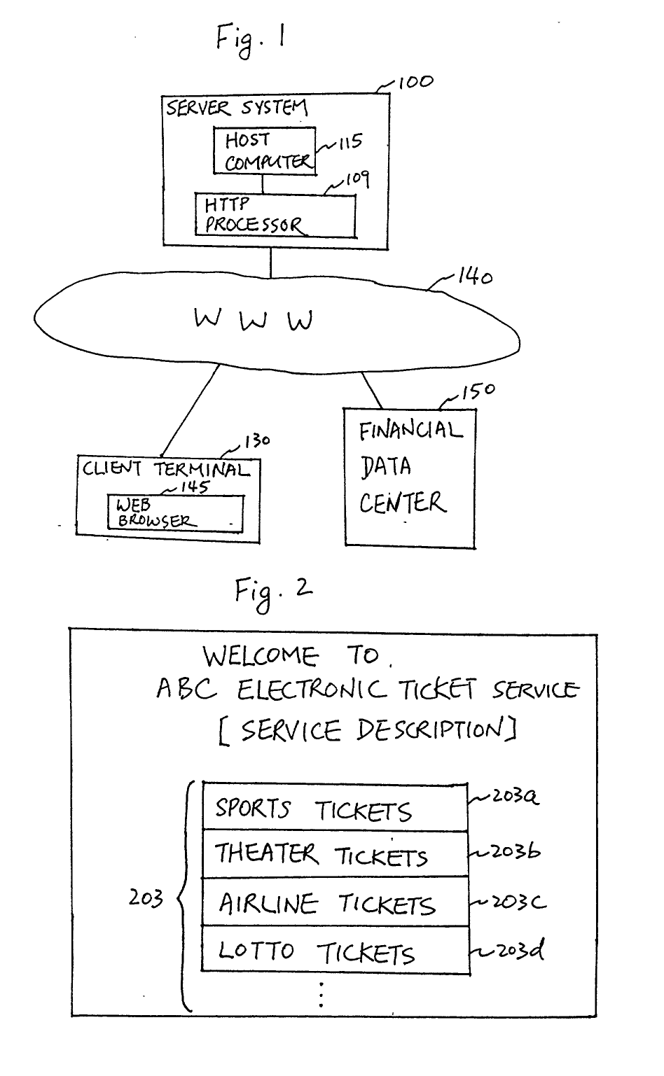

As soon as the connection between browser 145 and processor 109 is established, processor 109 in a well known manner causes a home page in HTML to be displayed on terminal 130. FIG. 2 illustrates such a home page, which includes a greeting such as “Welcome to ABC Electronic Ticket Service,” followed by a description of the subject service. It also includes menu 203 providing selectable options such as sports ticket option 203a, theater ticket option 203b, airline ticket option 203c, lotto ticket option 203d, etc. In this example, the user XYZ utilizes a mouse device (not shown) connected to terminal 130 to point and click at option 203a to purchase a ticket for a basketball game. Web browser 145 transmits information concerning the user selection to HTTP processor 109. In response, processor 109 obtains an HTML document representing a SPORTS page from host computer 115 and transmits same to web browser 145.

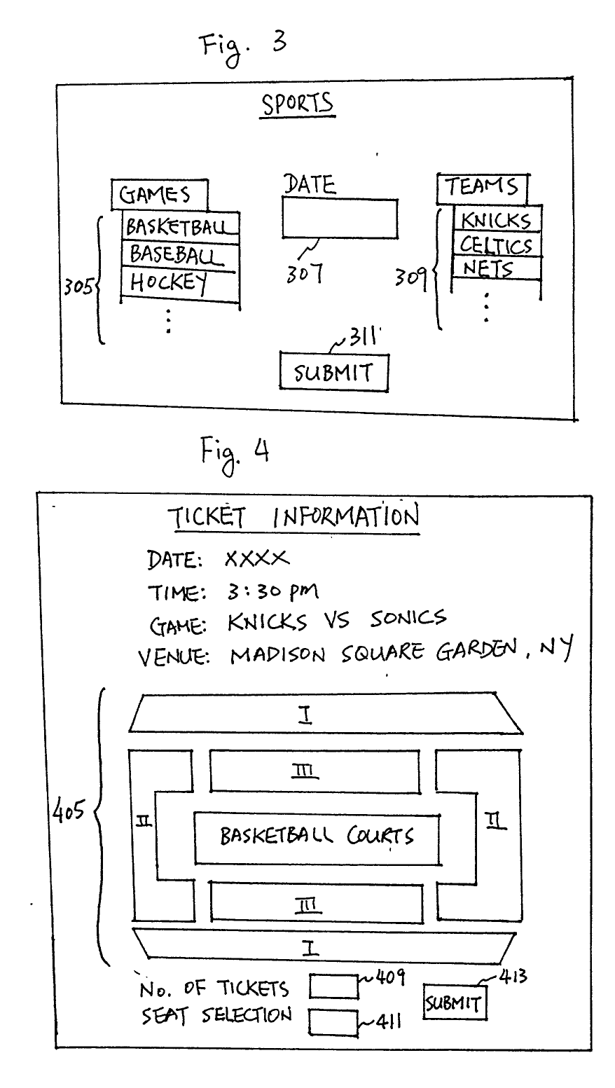

Browser 145 opens the received HTML document, resulting in a display of the SPORTS page on terminal 130. FIG. 3 illustrates such a page where the user XYZ selects a sport of interest from drop down menu 305, e.g., “basketball” in this instance. In addition, the user is prompted to enter the date of the game of interest in box 307. In response, the user enters the desired game date. The user is also prompted to select a team from drop down menu 309 which identifies only those basketball teams playing on the date just entered. In this instance the user selects “KNICKS” as the basketball team of interest. Upon the user's selection of SUBMIT option 311, browser 145 then tr nsmits the user entries to HTTP processor 109, which in turn provides the received data to host computer 115. The latter prepares an HTML document representing TICKET INFORMATION based on the received data. This HTML document is then transmitted to web browser 145 through processor 109.

Web browser 145 opens the received HTML document, resulting in a display of the TICKET INFORMATION page on terminal 130. FIG. 4 illustrates such a page, which specifies the game of interest, and its date, time and venue. In addition, the user XYZ is provided with seating chart 405, indicating a distribution of seats in three sections, namely, sections I, II and III. In a conventional manner, seats in different sections correspond to different ticket prices. The user is also prompted to enter in box 409 the number of tickets that the user wants to purchase, and in box 411 the seat section for which the tickets are purchased. In this instance, the user enters “III” as the desired seat section, and “111” as the desired number of tickets to be purchased.

Upon the user's selection of SUBMIT option 413, browser 145 transmits the user entries to HTTP processor 109, which in turn forwards the received data to host computer 115 to check for the seat availability. If host computer 115 determines that the seat requirement by the user cannot be fulfilled, it causes HTTP processor 109 to re-transmit the TICKET INFORMATION page, with a message indicating unfulfillment of the user seat requirement. The user may then reselect the desired seat section and/or number of tickets. Otherwise, if host computer 115 determines that one or more seats are available in section III, host computer 115 reserves one of the seats and causes processor 109 to transmit a PAYMENT METHOD page to terminal 130. FIG. 5 illustrates such a page where the identity of the reserved seat, and the ticket price therefor are displayed. In addition, the user is prompted for information concerning the method of payment.

For example, the user XYZ at this point may select option 503 to have the ticket price charged to his/her credit card account as in prior art. However, knowing that in doing so his/her personal financial information, i.e., the credit card number in this instance, would be kept somewhere in server system 100, the user may refrain from providing such personal financial information, stemming from the user's concern about the security of system 100. Since the security of individual merchant servers, including system 100, may vary drastically from one to another, the personal financial information stored in any unsecure merchant servers is subject to theft by computer hackers breaking thereinto.

However, with an inventive financial service used here, no customers' personal financial information is kept in merchant servers. Rather, it is stored in financial data center 150 which handles the finance attendant to online transactions. Thus, by using the inventive financial service, only financial data center 150 is required to be equipped with stringent, normally costly, security measures against any hacker's stealing the sensitive personal financial information stored therein, as opposed to requiring each merchant server to be equipped with the costly security measures as would be in the prior art case.

In this instance, financial data center 150 is equipped with firewalls, and other necessary computer security measures against hackers. Thus, financial data center 150 is required to be the only site on WWW 140 where users' personal financial information is securely kept in carrying out the inventive financial service. In addition, in consummating online transactions using the inventive financial service, no personal financial information is exposed on WWW 140.

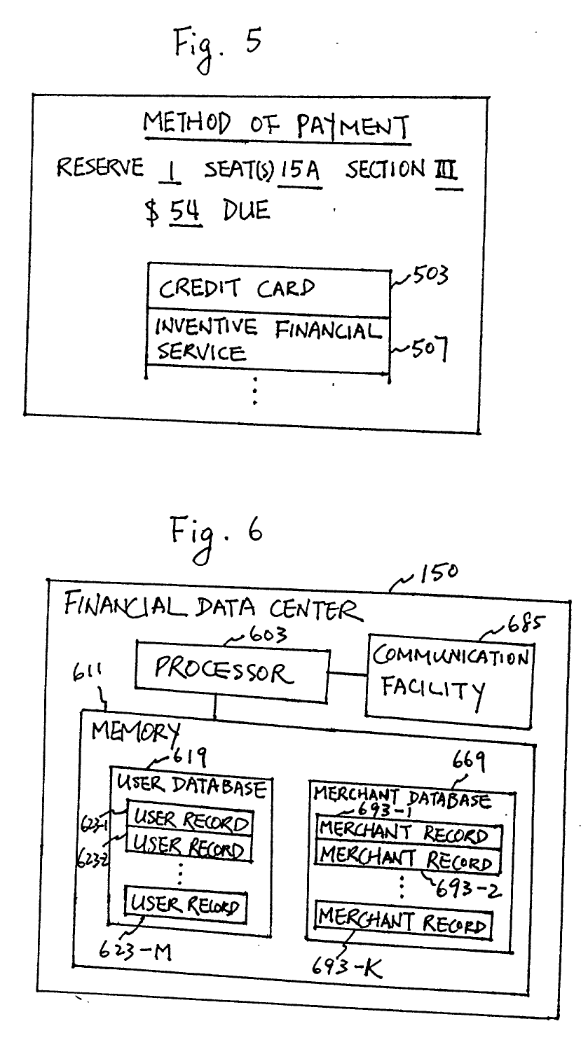

FIG. 6 illustrates financial data center 150 which comprises processor 603, memory 611, and communication facility 685 for use by processor 603 to communicate information via WWW 140. Memory 611 contains user database 619 including user records 623-1 through 623-M, which are associated with different users subscribing to the inventive financial service, where M represents the number of such users.

When each user, e.g., XYZ in this instance, subscribes to the inventive financial service, a user account is established for the user to finance online transactions conducted through financial data center 150. The user account may be funded by electronic funds transfer from an external account such as a checking account, credit card account, savings account, debit account, credit-revolving account, etc., which the user established with a financial institution, e.g., a bank, credit card company, etc. Such electronic funds transfer may be accomplished using a well known technique. For example, one such technique may be a tele-meter setting (TMS) technique used for remotely replenishing a postage fund in a secure vault in a postage meter for postage dispensation. For details on the TMS technique, one may refer to U.S. Pat. No. 5,715,164 issued Feb. 3, 1998 to Liechti et al.

FIG. 7 illustrates the format of generic user record 700. As shown in FIG. 7, record 700 includes field 703 which contains user identification (ID) data identifying the user associated with the record, field 705 which contains a password pre-selected by the user for user verification, field 707 which contains personal information concerning the external account enabling center 150 to transfer funds between the external account and the user account, field 709 which contains data concerning the balance of the user account, field 711 which contains information concerning the user's purchases, and field 713 which contains a user e-mail address for center 150 to communicate with the user.

It should be noted that field 705 may contain other user personal identification information, such as a personal identification number (PIN) or information concerning the user biometrics, in addition to or in lieu of the user password for user verification. Such biometrics may include the user's retinal pattern, DNA composition, fingerprints, etc.

Memory 611 also contains merchant database 669 including merchant records 693-1 through 693-K, which are associated with different merchants participating in the inventive financial service, where K represents the number of participating merchants.

For each participating merchant, e.g., ABC in this instance, a merchant account is established with the inventive financial service for receiving, from one or more of the user accounts described above, payments for online transactions within center 150. The merchant account may be reconciled periodically by electronically transferring funds therein to a specified external account, e.g., a checking account, savings account, etc., which the merchant established with a financial institution.

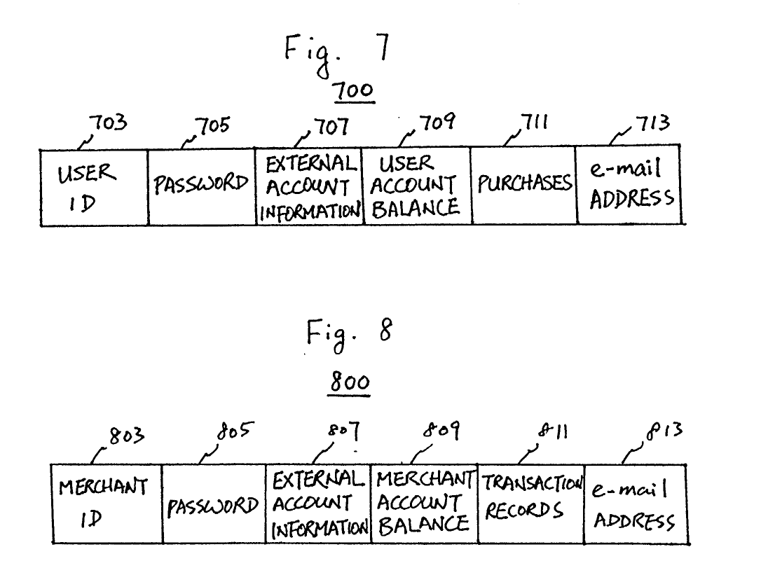

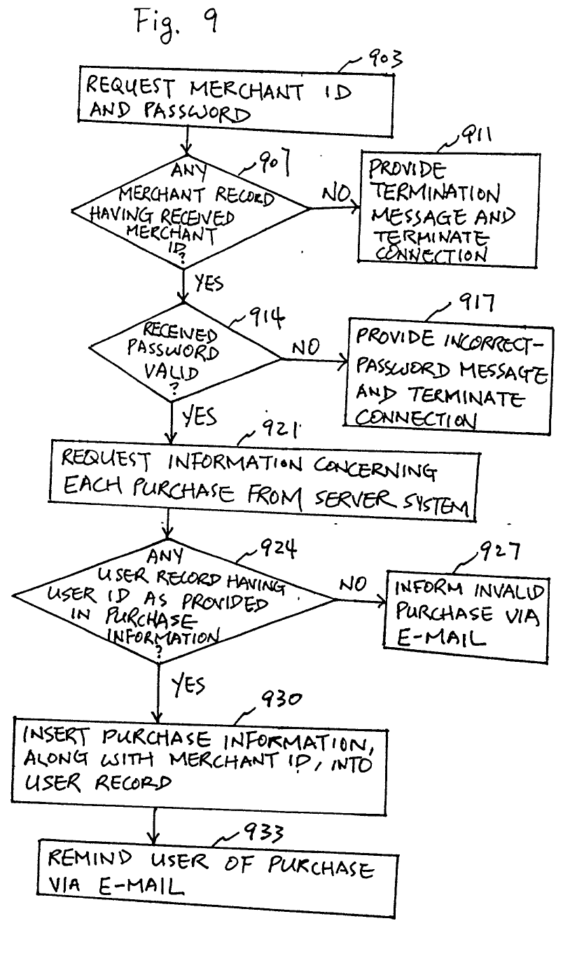

FIG. 8 illustrates the format of generic merchant record 800. As shown in FIG. 8, record 800 includes field 803 which contains merchant identification (ID) data identifying the merchant associated with the record, field 805 which contains a password pre-selected by the merchant for merchant verification, field 807 which contains information concerning the external account enabling center 150 to transfer funds between the external account and the merchant account, field 809 which contains data concerning the balance of the merchant account, field 811 which contains transaction records resulting from users' purchases, and field 813 which contains a merchant e-mail address for center 150 to communicate with the merchant.

It should also be noted that field 805 may contain other merchant identification information in addition to or in lieu of the merchant password for merchant verification.

Referring back to FIG. 5 and continuing the above example where the user XYZ is prompted to select a method of payment for the basketball game ticket, the user, who is a subscriber to the inventive financial service in this instance, selects option 507 to use the inventive financial service to pay for the ticket. In response to such a selection, the user XYZ is prompted by system 100 to provide his/her user ID with the inventive financial service. After sending the user ID to system 100, the user may terminate the communication connection with system 100. The user may then communicate with other merchant servers similar to system 100 through WWW 140 for additional purchases using the inventive financial service.

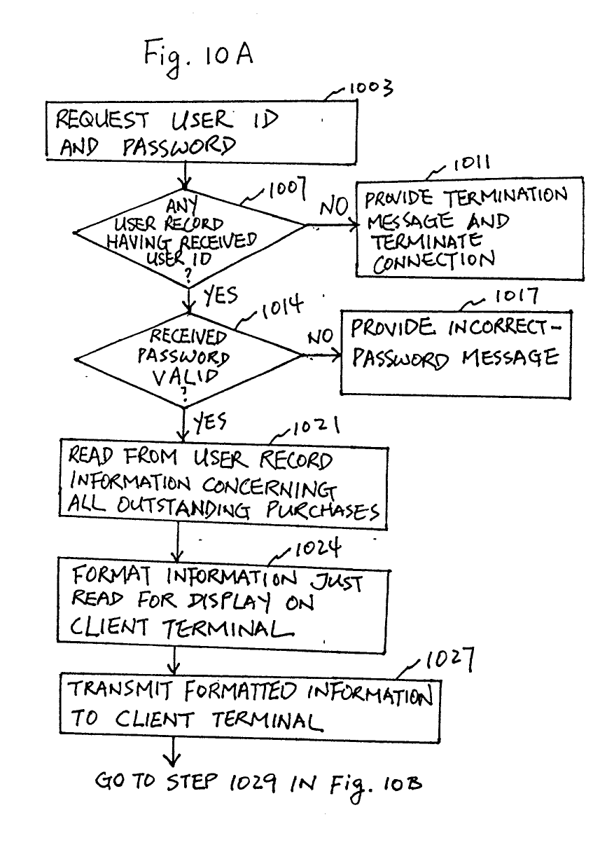

System 100 subsequently establishes a communication connection with processor 603 through communication facility 685 in data center 150. This communication connection may be secure and the communication information provided thereon may be encrypted and/or authenticated. Through the established connection, processor 603 requests from system 100 a merchant ID and password for verifying that the merchant associated with system 100 is indeed an authorized participating merchant, as indicated at step 903 in FIG. 9. After receiving the merchant ID and password provided by system 100, processor 603 searches database 669 for the merchant record having field 803 containing the received merchant ID, as indicated at step 907. If no such merchant record can be found, processor 603 at step 911 provides to system 100 a termination message and terminates the connection therewith. Otherwise, if such a merchant record is found, processor 603 at step 914 verifies the received password by checking it against the merchant password in field 805 of the record. If the password is not validated, processor 603 at step 917 provides to system 100 an incorrect-password message, and terminates the connection therewith. Otherwise, if the password is validated, processor 603 at step 921 requests server system 100 to provide information concerning each purchase therefrom, including the date and time of the purchase, description of the purchase, purchase amount, user ID associated with the purchase, and receipt data.

Without loss of generality, let's assume that in this instance the received purchase information concerns only the ticket purchase by the user XYZ. Processor 603 at step 924 searches database 619 for a user record having field 703 containing the XYZ user ID as provided in the received purchase information. If no such record is found, processor 603 at step 927 causes transmission of an e-mail message to server system 100, informing the merchant ABC that the purchase is invalid.

Otherwise, if the user record is found, the received purchase information, along with the ABC merchant ID, is inserted into field 711 of the user record, as indicated at step 930. Processor 603 at step 933 causes transmission of an e-mail message to the user XYZ with the user e-mail address in field 713, reminding the user of his/her purchase from ABC Electronic Ticket Service.

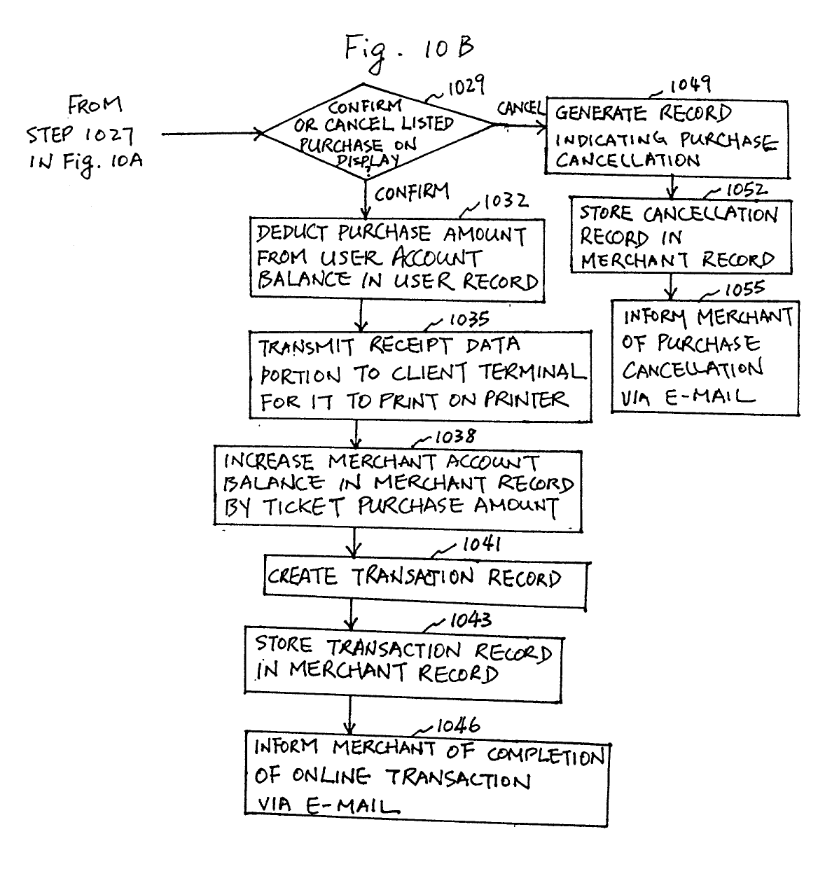

In this illustrative embodiment, each purchase by the user XYZ is reserved for him/her for a predetermined time from the purchase. Within the predetermined time, the user may utilize client terminal 130 to establish a communication connection with processor 603 through communication facility 685 in data center 150. This communication connection may be secure, and the communication information provided thereon may be encrypted and/or authenticated. Through the established connection, processor 603 requests from terminal 130 a user ID and password for verifying that the user is indeed a subscriber to the inventive financial service, as indicated at step 1003 in FIG. 10A. After receiving the user ID and password provided by terminal 130, processor 603 searches database 619 for the user record having field 703 containing the received user ID, as indicated at step 1007. If no such user record can be found, processor 603 at step 1011 provides to terminal 130 a termination message and terminates the connection therewith. Otherwise, if such a user record is found, processor 603 at step 1014 verifies the received password by checking it against the user password in field 705 of the record. If the password is not validated, processor 603 at step 1017 provides to terminal 130 an incorrectpassword message, and terminates the connection therewith. Otherwise, if the password is validated, processor 603 at step 1021 reads, from field 711 of the user record, information concerning all outstanding purchases by the user XYZ using the inventive financial service, including the information concerning the aforementioned ticket purchase in this instance. Processor 603 at step 1024 formats the information just read for display on client terminal 130, and at step 1027 transmits the formatted information to client terminal 130 for its display thereon.

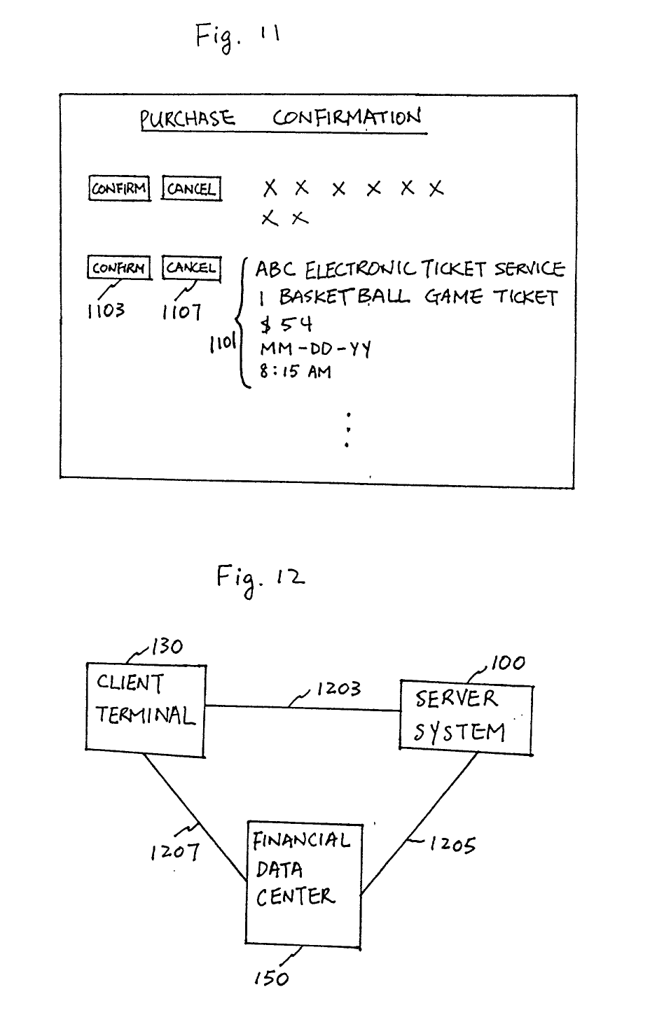

After receiving the formatted information, terminal 130 displays thereon a purchase confirmation screen. FIG. 11 illustrates such a screen where each outstanding purchase by the user is listed for the user to confirm. For example, listing 1101 includes information concerning the aforementioned ticket purchase from ABC Electronic Ticket Service, purchase price, and purchase date and time. The user is afforded a choice to confirm or cancel each listed purchase on display, as indicated at step 1029 in FIG. 10B. For example, the user may point and click at option 1103 to confirm the ticket purchase indicated by listing 1101. In that case, processor 603 deducts the ticket purchase amount from the XYZ user account balance in field 709 of the user record, as indicated at step 1032. Processor 603 at step 1035 transmits the receipt data portion of the purchase information in field 711 of the user record to client terminal 130 for it to print on a printer (not shown) connected to terminal 130.

In this instance, the user XYZ relies on the printed receipt serving as proof of the purchase to gain admission to the basketball game in question. To that end, the printed receipt includes thereon an indicium representing the necessary admission information. Such an indicium may include human readable text and/or machine readable code, e.g., a barcode.

Processor 603 at step 1038 increases the merchant account balance in field 809 of the ABC merchant record by the ticket purchase amount previously deducted from the user account, thereby completing the online transaction. Processor 603 at step 1041 creates a transaction record including the user ID identifying the user XYZ, purchase amount, and date and time of the transfer of the purchase amount to the ABC merchant account. Processor 603 at step 1043 stores this transaction record in field 811 of the ABC merchant record for audit purposes. Processor 603 at step 1046 transmits an e-mail message to system 100, informing the merchant of the completion of the online transaction.

Returning to step 1029, if the user XYZ points and clicks at option 1107 to cancel the ticket purchase indicated by listing 1101, instead, processor 603 at step 1049 generates a record indicating the purchase cancellation. Processor 603 at step 1052 stores the cancellation record in field 811 of the ABC merchant record. Processor 603 at step 1055 transmits an e-mail message to system 100, informing the merchant of the purchase cancellation.

The foregoing merely illustrates the principles of the invention. It will thus be appreciated that those skilled in the art will be able to devise numerous other arrangements which embody the principles of the invention and are thus within its spirit and scope.

For example, referring to FIG. 12, in the disclosed embodiment the sequence of communications for conducting an online transaction illustratively is (a) communications between client terminal 130 and server system 100 concerning a purchase through communication connection 1203 via Www 140, and then (b) communications between server system 100 and financial data center 150 concerning purchase information through communication connection 1205 via WWW 140, followed by (c) communications between client terminal 130 and financial data center 150 through communication connection 1207 via WWW 140 to complete the transaction. In the disclosed embodiment connections 1203, 1205 and 1207 are illustratively established and terminated in that order. However, in an alternative embodiment, connections 1203, 1205 and 1207 may coexist to complete the whole transaction (i.e., purchase and funds transfer of the purchase amount from the user account to the merchant account) in real time.

Finally, server system 100 and financial data center 150 are disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

It will become apparent to one skilled in the art that many variations of the invention may be implemented. For example, while particular Internet protocols are discussed above, it will be apparent that new Internet and non-Internet types of protocols (and associated different types of browsers) can be used. It may be desirable, in a particular application, to use a different protocol if, for example, a private network is used, rather than the Internet. Further, the connections on any network, may be wired or wireless, including those using RF, infrared, or any other types of communication hardware or software.

It will also be recognized that if a public key/private key encryption technique, such as PGP, is used for communication, then a password is not required, because only a recipient of the information (generally the seller) can decrypt the communications. However, a password can still be used, thus supplying an extra layer of security protection.

Various methods of payment may be used in connection with the inventive financial service and system. A customer may establish a line of credit with the financial data center. Or as described above, the financial data center may simply have access to one or more of a customer's credit card accounts.

In this case, the balance in the customer's account may be quite low. In fact, no funds need be on account. As an additional, but less desirable approach (from the point of view of the customer) the customer may transfer funds to the financial data center in advance of making purchases.

The system and method in accordance with the invention, when providing a printed receipt that includes thereon an indicium representing proof of payment, may provide the indicium with suitable encrypted content within, or associated with, the indicium to guarantee that the indicium is genuine (and not fraudulently produced) so that when optically scanned by an appropriate device, or read by a person, the authenticity of the receipt may be verified. For example, the indicium may include a digital signature coded as a twodimensional bar code.

It is an important additional aspect of the present invention that the various parties (the financial center, the customer and the merchant) may use secure sources of funds, such as postal security devices (PSD's) to transfer funds or information. These devices, of a type well known in the art, have an ascending register, a descending register, and utilize encryption technology. When used in a postal metering system, funds are generally transferred into these devices using a telemetering system (TMS).

This technology may be used in the present invention with several very significant advantages. The encryption technology associated with these devices allows them to exchange encryption keys on a session by session basis. Keys may be used for multiple sessions or for a single session to enhance security. Funds may be transferred directly between the customer and the merchant, thus effectively eliminating the need for a large server. In addition, it is not only funds that can be transferred. Using the PSD technology permits data to be securely transferred as well. This can be credit card information so that a purchase can be charged to a particular customer's credit card. However, it can also be information which has independent value. Such information may includes that used to produce tickets, with, for example, an indicium of payment, as described above. It may also include computer files associated with books, movies, audio (such as that typically recorded on CD's), or other data, such as that provided by subscriptions to financial information services, etc. In all of these cases, the merchant need do nothing but send the data, over a suitable connection, to the customer. However, the transaction can be securely conducted due to the security measurement associated with the PSD.

Finally, the method and system in accordance with the invention may include non-repudiation technology, so that both the merchant and the customer are assured that they are protected if the other party attempts to repudiate the transaction. For example, digital signatures or certificates may be utilized. In this case, information concerning, for example, the time, date and other particulars of the transaction may be coded into the digital certificate so that the transaction may be verified at a later time. A digital signature is linked to a unique public/private key pair.

It should be understood that the foregoing description is only illustrative of the invention. Various alternatives and modifications can be devised by those skilled in the art without departing from the invention. Accordingly, the present invention is intended to embrace all such alternatives.

What is claimed is:

1. A method for conducting electronic commerce for customers subscribing to a service, comprising:
establishing a customer account for each customer subscribing to the service;
establishing a merchant account for each merchant website participating in the service;
storing account information of the customer account and that of the merchant account within a financial server, wherein sensitive financial information required for funding the respective accounts is also stored in the server.

2. The method of claim 1, wherein after a customer makes a purchase from a merchant using the service, the merchant provides to the financial server information concerning the purchase via a first communication connection.

3. The method of claim 2, wherein the information includes, a purchase amount, a first identification for identifying the customer account and a second identification for identifying the merchant account.

4. The method of claim 3, wherein to complete the purchase, the customer provides to the financial server an affirmation of the purchase via a second communication connection.

5. The method of claim 4, wherein in response to said affirmation, the financial server causes a transfer of a value between the customer account and the merchant account, where the value if a function of the purchase amount.

6. The method of claim 5, wherein when said merchant is notified of said transfer, said merchant sends at least one item purchased to a customer.

7. The method of claim 6, wherein said at least one item includes goods.

8. The method of claim 6 wherein said at least one item purchased include an entry permission.

9. The method of claim 8, wherein said entry permission is to an entertainment event.

10. The method of claim 8, wherein said at least one item includes an indicium evidencing payment.

11. The method of claim 10, wherein said indium includes at least one of human readable text or machine readable code.

12. The method of claim 11, wherein said machine readable code includes a digital signature.

13. The method of claim 11, wherein said machine readable code is encrypted.

14. The method of claim 8, wherein said at least one item includes a printed receipt serving as proof of purchase.

15. A system for providing an electronic commerce service, comprising:
a server having a customer account for each customer subscribing to the service;
a merchant account for each merchant participating in the service;
storage apparatus for storing account information of the customer account and account information of the merchant account, said storage apparatus also being for storing sensitive financial information required for funding the respective accounts;
a first communication connection for the merchant to provide to the server information concerning a purchase; and
a second communication connection for the customer to provide to the server an affirmation of the purchase.

16. The system of claim 15, further comprising:
means for causing the server to transfer a value between the customer account and the merchant account, where the value is a function of a purchase amount for an item purchased.

17. The system of claim 15, wherein the information provided by said merchant using said first communication connection includes a purchase amount, a first identification for identifying the customer account and a second identification for identifying the merchant account.

18. The system of claim 15, further comprising means to encrypt communications provided by at least one of said first communication connection and said second communication connection.

19. The system of claim 15, further comprising authentication means for applying non-repudiation information to at least one of said first communication connection and said second communication connection.

20. The system of claim 19, wherein said nonrepudiation information includes a digital signature.

21. The system of claim 15, wherein said nonrepudiation information includes a digital certificate.

22. The system of claim 21 wherein said digital certificate includes information about particulars of a transaction evidenced by said certificate.

23. The system of claim 14, wherein said storage apparatus includes a postal security device.

24. A method for transferring information from one user of a system to another, said information including at least one of sensitive financial information, funds, or other data, said method comprising:
a first user encoding said information using a secure apparatus, including a first postal security device and sending said information to a second user;
said second user receiving and decoding said information using a second secure apparatus including a second postal security device.

25. The method of claim 24, further comprising using a non-repudiation technique to conduct said method.

26. The method of claim 24, wherein said nonrepudiation technique include affixing a digital signature or a digital certificate to said information.
